(19) United States
(12) Patent Application Publication
(10) Pub. No.: US 2025/0106908 A1
(43) Pub. Date: Mar. 27, 2025

(54) FINE RANGING LINK LAYER CONTROL

(71) Applicant: Qorvo US, Inc., Greensboro, NC (US)

(72) Inventor: Eric Perraud, Plaisance du Touch (FR)

(21) Appl. No.: 18/832,067

(22) PCT Filed: Feb. 2, 2023
(86) PCT No.: PCT/US2023/061802

§ 371 Date: Jul. 22, 2024

Related U.S. Application Data
(60) Provisional application No. 63/306,204, filed on Feb. 3, 2022.
(60) Provisional application No. 63/312,990, filed on Feb. 23, 2022.
(60) Provisional application No. 63/367,536, filed on Jul. 1, 2022.
(60) Provisional application No. 63/369,110, filed on Jul. 22, 2022.

(51) Int. Cl. H04W 76/10; H04L 69/321; H04W 28/02; H04W 80/02; H04W 80/12

(52) U.S. Cl. CPC H04W 76/10; H04L 69/321; H04W 28/0268; H04W 80/02; H04W 80/12

(57) ABSTRACT

Systems and methods for fine ranging (FiRa) link layer control in ultra-wideband (UWB) enabled devices are disclosed. In one aspect, a link layer control plane acts as a black box to an application developer requiring minimal inputs therefrom, but allows connections to be created, paused, resumed, and/or deleted as needed or desired. Exemplary inputs include a qualify of service indicator, target bitrate, disorder metrics, maximum burst size and the like. By implementing aspects of the present disclosure, an application developer does not have to allocate UWB resources, simplifying the design process for the application developer. Further and more specifically, exemplary aspects of the present disclosure allow the link layer to establish, stop, or resume connections and high-level requests from an application may be translated into MAC or link layer parameters.

### PRIORITY APPLICATIONS

The present application is a 35 USC 371 national phase filing of International Application No. PCT/US2023/061802, filed Feb. 2, 2023, which claims priority to U.S. Provisional Patent Application Ser. No. 63/306,204 filed on Feb. 3, 2022 and entitled “LINK LAYER CONTROL IN ULTRA WIDEBAND SYSTEMS,” the contents of both of which are incorporated herein by reference in their entireties.

PCT application PCT/US2023/061802 also claims priority to U.S. Provisional Patent Application Ser. No. 63/367,536 filed on Jul. 1, 2022 and entitled “FINE RANGING LINK LAYER CONTROL,” the contents of which are incorporated herein by reference in its entirety.

PCT application PCT/US2023/061802 also claims priority to U.S. Provisional Patent Application Ser. No. 63/312,990 filed on Feb. 23, 2022 and entitled “UWB SLOT SCHEDULER,” the contents of which are incorporated herein by reference in its entirety.

PCT application PCT/US2023/061802 also claims priority to U.S. Provisional Patent Application Ser. No. 63/369,110 filed Jul. 22, 2022, and entitled “FINE RANGING SLOT SCHEDULER,” the contents of which are incorporated herein by reference in its entirety.

### BACKGROUND

### I. Field of the Disclosure

The technology of the disclosure relates generally to defining link layers in the Fine Ranging (FiRa) standard for ultra-wideband (UWB) systems.

### II. Background

Computing devices abound in modern society, and more particularly, mobile communication devices have become increasingly common. The prevalence of these mobile communication devices is driven in part by the many functions that are now enabled on such devices. Increased processing capabilities in such devices means that mobile communication devices have evolved from pure communication tools into sophisticated mobile entertainment centers, thus enabling enhanced user experiences.

One such function is the introduction of fine ranging (FiRa). In April of 2020, the FiRa Consortium published “PHY Technical Requirements” setting forth physical layer (PHY) requirements based on IEEE 802.15.4z standard for ultra-wideband (UWB)-enabled devices. The FiRa Consortium followed this with the publication of “UWB MAC Technical Requirements” in May of 2020. While these two documents set forth requirements to be FiRa-certified UWB-enabled devices, there remains room in these specifications for specific details to be defined.

In particular, new use cases such as payment transactions need some way for the applications to interface with the UWB frames.

### SUMMARY

Aspects disclosed in the detailed description include systems and methods for fine ranging (FiRa) link layer control in ultra-wideband (UWB)-enabled devices. In particular, exemplary aspects of the present disclosure contemplate a link layer control plane that acts as a black box to an application developer requiring minimal inputs therefrom, but allows connections to be created, paused, resumed, and/or deleted as needed or desired. Exemplary inputs include a qualify of service (QOS) indicator, target bitrate, disorder metrics, maximum burst size, and the like. By implementing aspects of the present disclosure, an application developer does not have to allocate UWB resources, simplifying the design process for the application developer. Further and more specifically, exemplary aspects of the present disclosure allow the link layer to establish, stop, or resume connections and high-level requests from an application may be translated into MAC or link layer parameters.

In this regard in one aspect, an integrated circuit (IC) is disclosed. The IC comprises an ultra-wideband circuit comprising a control circuit. The control circuit is configured to communicate with an application layer through a universal command and control interface (UCI) command. The control circuit is also configured to use link layer signals to communicate to a remote device.

### BRIEF DESCRIPTION OF THE DRAWINGS

FIG. 1 is a stylized representation of computing devices within a predefined distance such that Fine Ranging (FiRa) communication may occur;

FIG. 2A is a diagram of a protocol stack differentiating link level responsibilities from those of the application layer;

FIG. 2B is a more detailed view of a link layer control plane in the protocol stack of FIG. 2A;

FIG. 3 is a signal flow diagram between the controller of a FiRa communication and a controlee; and

FIG. 4 is a signal flow diagram showing connection creation between the controller and controlee.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects disclosed in the detailed description include systems and methods for fine ranging (FiRa) link layer control in ultra-wideband (UWB)-enabled devices. In particular, exemplary aspects of the present disclosure contemplate a link layer control plane that acts as a black box to an application developer requiring minimal inputs therefrom, but allows connections to be created, paused, resumed, and/or deleted as needed or desired. Exemplary inputs include a qualify of service (QOS) indicator, target bitrate, disorder metrics, maximum burst size, and the like. By implementing aspects of the present disclosure, an application developer does not have to allocate UWB resources, simplifying the design process for the application developer. Further and more specifically, exemplary aspects of the present disclosure allow the link layer to establish, stop, or resume connections and high-level requests from an application may be translated into MAC or link layer parameters.

Before addressing particular aspects of the present disclosure, some additional background information is provided. In particular, the FiRa Consortium has proposed FiRa as a UWB technology that allows connections between peer devices and which allows secure transactions between a controller device and a controlee device when the two are within a predefined distance of each other. Some possible use cases are payment transactions or streaming of content. The current language of the specification calls for a media access control (MAC) layer for inband data transfer and a link layer, but currently the specification is silent about how to create and manage connections between the controller and controlee(s) or how UWB resources are allocated. This silence leads to room for innovation, particularly to help an application developer handle connections.

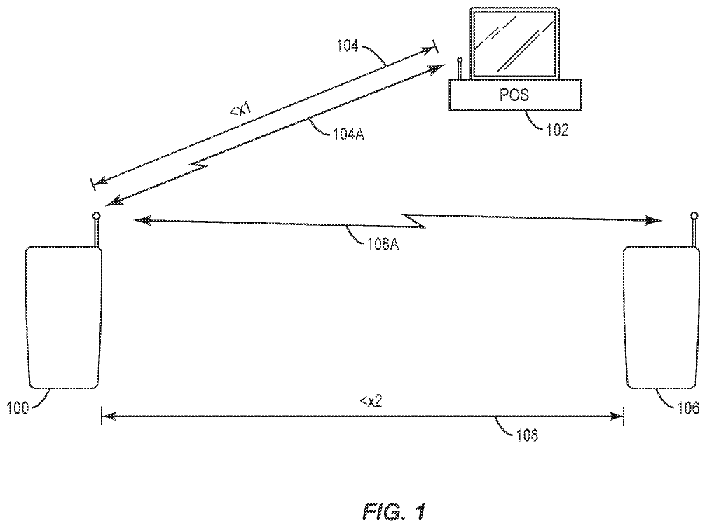

In this regard, FIG. 1 is stylized representation of a mobile computing device 100 being within a predefined distance x1 of a computing device 102 (shown generally by line 104) and within a similar predefined distance x2 of a mobile computing device 106 (shown generally by line 108). The computing device 102 and/or the mobile computing device 106 may each be a point of sale (POS) device, a video streaming source, a file transfer source, or the like. As such, with respect to the mobile computing device 100, the computing device 102 and the mobile computing device 106 may be controllers and the mobile computing device 100 may be a controlee within FiRa communications. More specifically, wireless communication signals 104A and 108A may exist between the mobile computing device 100 and the computing device 102 and mobile computing device 106, respectively.

Exemplary aspects of the present disclosure provide a link layer (LL) control plane to facilitate establishing communication links for signals 104A, 108A. In particular, the LL control plane acts as a black box to abstract all the UWB logical connection creation and management so that application developers do not have to program such details. It should be appreciated, that while not shown, the mobile computing device 100, the computing device 102, and the mobile computing device 106 may include a control circuit that, with software, implements aspects of the present disclosure.

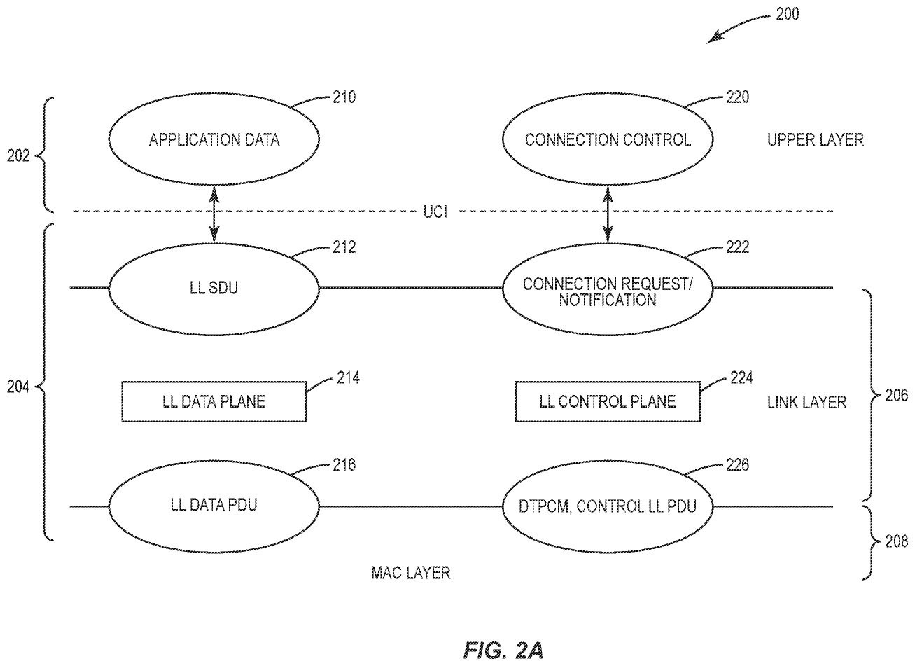

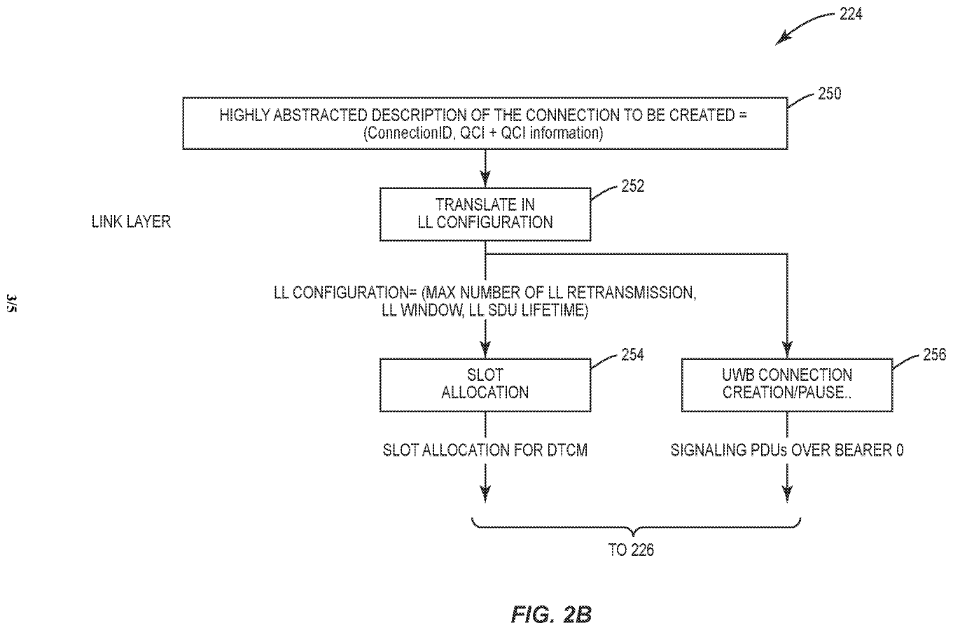

FIG. 2A illustrates a protocol stack 200, which has an upper layer 202 and a lower layer 204 separated conceptually by a universal command and control interface (UCI). Within the lower layer 204, there is a LL 206 and a MAC layer 208. To assist application developers who want to use FiRa, the UCI line is conceptually above the LL 206. The application developer may designate application data 210, which is passed through the UCI line as a LL service data unit (SDU) 212 where a LL data plane 214 constructs a LL protocol data unit (PDU) 216. Alternatively, application data may be passed through the interface to a secure component (as that term is used in the FiRa standard) over a secure interface. The LL PDU 216 is the payload of the signaling messages that are conveyed by the MAC layer 208, to create the logical connections.

With continued reference to FIG. 2A, the application developer may also provide basic connection control 220 which includes commands such as create, pause, resume, and delete, but no details about the UWB functionality that performs these commands. Such commands are passed through the UCI line to a connection request/notification function 222 in the LL 206. A LL control plane 224 according to the present disclosure has two main functions: translate the high-level description of the connection into a UWB configuration and then allocate the UWB channel resources between the controller and controlee. To do so, the LL 206 may use a data transmission phase control message (DTPCM) 226 that packages the PDU for transmission by the MAC layer 208.

More detail about the LL control plane 224 is provided in FIG. 2B, wherein an input of information 250 of a highly-abstracted description of the connection to be created (i.e., a connection identifier, a quality of class indicator and associated information) is provided to a logic element 252 that translates the information 250 to a LL configuration. This LL configuration may include a maximum number of LL retransmissions, a LL window, a LL SDU lifetime, or the like. This allows a logic element 254 to create slot allocations and a logic element 256 to make UWB connection creation/pause commands or the like.

Thus, for the first function, the LL control plane 224 of the controller considers all the requests of the logical connection creation and also solicits how the upper layer clients (i.e., the application) intend to use the logical connection. Thus, the application developer may designate in the application what the use is as well as whether the connection is unidirectional or bidirectional in the upper layer 202. Additionally, the developer may provide an indication of what a target volume of data to be exchanged is. There may additionally be some indications as to how critical latency is; if latency is critical, what is a target guaranteed latency; what is the typical delay between a request and a response; and what is the typical size of a request or a response. One or more of these indications may be needed for authentication/payment use cases. Further, the developer may provide an indication if the bitrate is critical and any guaranteed bitrate. As still another option, the developer may provide an indication as to whether the connection is not critical (e.g., background process) and only uses best effort data transfers.

In an exemplary aspect, the LL 206 exposes a high-level interface, which abstracts the UWB protocol. The semantic of this interface is relatively simple such that the developer only indicates the change in state of the link (create, pause, resume, delete) for a connection in the current data phase of the ranging round. The developer may also indicate the type of connection (latency critical, best effort, bitrate critical, or critical to delay between a request and a response) through a quality of service (QOS) class indicator (QCI). For example, QCI=0 may be a guaranteed bitrate for streaming use cases; QCI=1 for guaranteed latency connections such as for time-critical applications (e.g., authentication, payment, or ticketing); QCI=2 for a best effort connection such as for a peer-to-peer file transfer; and QCI=3 for Authentication Request/Response connections.

Having provided a QCI, the developer may have to provide additional information such as for QCI=1, the developer may specify a target bitrate and a disorder metric (i.e., how many frames can be received out of order and still allow the receiving application to reorder them with no noticeable impact on the user experience). Note that such disorder metric may be based on a size of a jitter buffer at the receiver. For guaranteed latency connections, the developer may also specify a maximum size of the burst data and an amount of data being transmitted. For QCI=3, the developer may also specify the delay between the request and the response and/or the size of an authentication request or response. Note that the list of QCI is not exclusive and there may be other sorts of auxiliary information provided by the application developer.

Table 1 provides details about a logical connection creation:

| PARAMETERS | COMMENTS |
|---|---|
| Connection ID | |
| Direction | Bidirectional or unidirectional |
| | If unidirectional, it defines the data |
| | direction (controller −> controlee or |
| | controlee −> controller) |
| QCI + QoS | QCI = 0, 1, 2, or 3 |
| additional | If 0, QoS additional information = target |
| information | bitrate |
| | If 1, QoS additional information = target |
| | latency |
| | If 3, QoS additional information = delay |
| | between request and response |

Table 2 provides details about a logical connection deletion:

TABLE 2
Logical Connection Deletion

| | |
|---|---|
| PARAMETERS | COMMENTS |

Connection ID

For the second function (i.e., create the connection), the LL control plane 224 of the controller uses this interface to create the UWB logical connections. The LL control plane 224 relies on radio data bearers between the UWB link layer entities to establish a logical connection between upper layers 202. The LL control plane 224 of the controller creates two radio data bearers per connection: one bearer from controller to controlee and one bearer from controlee to controller. The bearer carries either LL data, LL acknowledgements (ACK), or both, as shown by Table 3.

TABLE 3
Data Bearer content

| Upper Layer | Controller to Controlee (LL | Controlee to Controller (LL |
|---|---|---|
| Connection | DATA BEARER) | DATA BEARER) |
| Controller to Controlee | Upper Layer data | LL ACK Status (for received |
| only | | LL data Controller to |
| | | Controlee) |
| Controlee to Controller | ACK status (for received LL | Upper Layer data |
| only | data controlee to controller) | |
| Bidirectional | Upper Layer data | Upper Layer data |
| | ACK status (for received LL | ACK status (for received LL |
| | data Controlee to Controller) | data Controller to |
| | | Controlee) |

The concept of the data bearer to establish different connections makes the overall system very compact and reduces LL overhead in the data transfer itself. That is, every bearer has some attributes (e.g., a bearer which carries data has a transmit window, a maximum retransmission number, and a SDU lifetime; a bearer which carries only ACK does not). These bearer parameters are determined by the LL control plane 224 of the controller from the connection QCI and auxiliary information. These attributes or additional information (in particular, the maximum retransmission number) may be jointly considered by the first LL function to assist in slot assignment or the like.

For example, for a QCI=0 connection, the maximum retransmission number of the associated bearers is small, whereas for a QCI=2, the maximum retransmission number of the associated bearers is greater (to increase the bearer reliability). For QCI=2, the transmit window may be large to optimize a user's throughput, whereas for QCI=3, the transmit window may be tailored to match the size of the authentication request or response. Once these bearer attributes are determined and once the LL control plane 224 of the controller has allocated the internal resources of the UWB (buffer allocation to manage the transmit window, management of identifiers in the pool of identifiers, and the like), the LL control plane 224 builds and sends a control LL PDU 226 “create connection” as shown in Table 4. This control LL PDU 226 is sent over a signaling bearer which may be a broadcast bearer or a unicast connection. Each connection may be individually configured with a connection descriptor.

TABLE 4
CONTROL LL PDU: CREATE CONNECTION

| Field | Field content | Comment |
|---|---|---|
| Header | Bearer ID = 0 | Signalling bearer |
| | Signalling Information = “Create | |
| | Connection” | |
| Number of Connections | N | |
| List of N connections | Connection ID | |
| Connection descriptors | Bearer ID controller to controlee | ID of bearers which are |
| | Bearer ID controlee to controller | mapped to the connection |
| | | (shall be >1) |
| | LL addresses | Address of Controlees |
| | Max Retransmission number | Determined by LL |
| | | Control Plane from QCI and |
| | | QoS additional information |
| | Tx window | Determined by LL |
| | | Control Plane from QCI and |
| | | QoS additional information |
| | SDU lifetime | Determined by LL control |
| | | plane from QCI and QoS |
| | | additional information |
| | Packet concatenation or | |
| | segmentation enabled | |

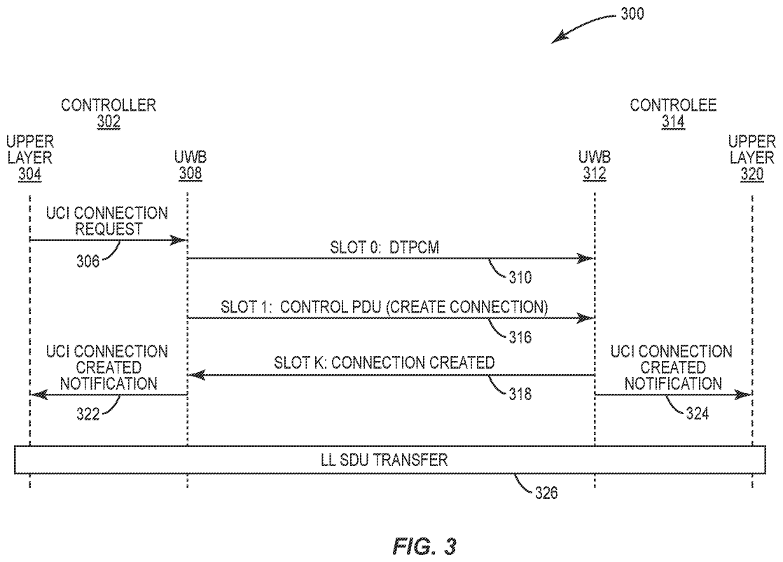

FIG. 3 illustrates a signal flow 300 for connection creation. In a controller 302, an upper layer 304 passes a UCI connection request 306 to a UWB system 308. The wireless transceiver within the UWB system 308 sends at slot zero a signal 310 with a DTPCM to a UWB system 312 in a controlee 314. The DTPCM determines the UWB slot allocation. The UWB system 308 sends at a slot one a signal 316 with a control PDU that has a create connection command. Alternatively, the controller 302 can send this create connection command in a unicast bearer for each connection to be created. In this case, the PDU has a single connection description. The controlee 314 responds with a later slot k (previously allocated to that specific controlee 314) signal 318 to the controller 302 indicating creation of the connection by using a control PDU over a signaling bearer with identifier one. The respective UWB systems 308 and 312 inform upper layer 304 and 320, respectively, of the connection creation through UCI 322, 324, respectively. Afterwards, data transfer may occur through a LL SDU transfer 326.

Table 5 provides a possible structure for the control PDU to acknowledge successful connection creation.

TABLE 5
Control PDU (create connections)

| Field | Field content | Comment |
|---|---|---|
| Header | Bearer ID = 1 | Signalling bearer |
| | Signalling Information = “Created | |
| | Connection” | |
| Connection ID | ID of the created connection | |

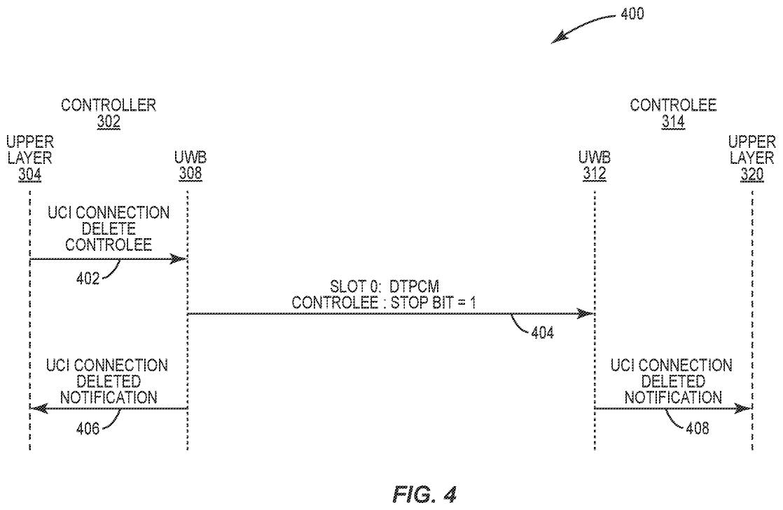

The controller 302 host may want to stop a connection after the upper layer 304 has finished its transaction or because the UWB link is broken. When the LL control plane 224 of the controller 302 receives this information over the interface, it does not allocate UWB slots to this device and sends a stop bit in a MAC control message which is sent as better seen by signal flow 400 in FIG. 4.

Specifically, the upper layer 304 detects a broken link or completed transaction and sends a UCI connection delete command signal 402 that identifies a particular controlee 314 to the UWB system 308. The UWB system 308 sends a slot zero signal 404 containing a DTPCM identifying the controlee 314 and a stop bit for the concerned controlee. After, both UWB systems 308 and 312 send a UCI connection deleted notification 406, 408, respectively.

Other signal formats may be possible without departing from the scope of the present disclosure. However, the examples provided herein allow for easy integration since the application developer uses an abstracted API to create and control connections with a semantic approach. The signaling is compact and low overhead while also allowing for different QoS demands to be met.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

Some of the material in the parent provisional is not readily integrated into the present discussion but remains relevant. Accordingly, portions of the parent provisional application are reproduced herein.

The following definitions, acronyms and abbreviations are applicable to this document.

TABLE 6
Definitions, Acronyms and Abbreviation

| Term | Definition |
|---|---|
| ACK | Acknowledgement |
| AD | Application Data |
| AE | Authenticated Encryption |
| AOA | Angle of Arrival |
| AR | Acknowledgment Request |
| BPRF | Base Pulse Repetition Frequency |
| CL | Connection-Less |
| CO | Connection-oriented |
| CRC | Cyclic Redundancy Check |
| CSM | Common Service & Management |
| DM | Data Message |
| DRBG | Deterministic Random Bit Generator |
| DS-TWR | Double-Sided Two-Way Ranging |
| DTPCM | Data Transfer Phase Control Message |
| DTPM | Data Transfer Phase Management |
| DUT | Device Under Test |
| ERDEV | Enhanced Ranging capable Device |
| HPRF | Higher Pulse Repetition Frequency |
| FCS | Frame Check Sequence |
| FOM | Figure of Merit |
| IE | Information Element |
| LL | Link Layer |
| LLCU | Link Layer Control Unit |
| LSN | Logical Sequence Number |
| MAC | Medium Access Control Layer |
| MRM | Measurement Report Message |
| MSB | Most Significant Bit |
| OOB | Out-of-Band |
| OUI | Organizationally Unique Identifier |
| OWR | One-Way Ranging |
| PAN | Personal Area Network |
| PHY | Physical Layer |
| PIB | Personal Area Network Information Base |
| PPDU | PHY Protocol Data Unit |
| PRF | Pulse Repetition Frequency |
| QCI | QoS Class Index |
| QoS | Quality of Service |
| RCP | Ranging Control Phase |
| RDEV | Ranging Device |
| RFRAME | Ranging Frame |
| RFM | Ranging Final Message |
| RIM | Ranging Initiation Message |
| RRM | Ranging Response Message |
| RSTU | Ranging Scheduling Time Unit |
| SFD | Start of Frame Delimiter |
| SI | Segmentation Indicator |
| SS-TWR | Single-Sided Two-Way Ranging |
| STS | Scrambled Timestamp Sequence |
| SPO | STS Packet Configuration 0 |
| SP1 | STS Packet Configuration 1 |
| SP3 | STS Packet Configuration 3 |
| ToF | Time of Flight |
| TWG | Technical Working Group |
| UCI | UWB Command Interface |
| UWB | Ultra Wideband |

TABLE 7
Control SDU

| | Size | |
|---|---|---|
| Parameter | (bits) | Notes |
| Type | 1 | 0b1: SDU is a control SDU |
| Number Of | 3 | Number of Data bearers which are created or deleted |
| Changed Data | | |
| Bearers | | |
| List of Data | | List of data bearer descriptors which have been created or |
| Bearer | | deleted |
| Descriptors | | |

Type field shall be set to 1 to indicate that the SDU is Control SDU.

Number Of Changed Data Bearers field indicates the number of data bearers to create, to resume or to delete.

List of Data Bearer Descriptors field is the list of descriptors of data bearers which have been created or deleted.

TABLE 8
Descriptor of Data Bearer Descriptor

| | Size | |
|---|---|---|
| Parameter | (bits) | Notes |
| ID | 8 | ID of the data bearer |
| Status & | 8 | Bits 0, 1 = 0b00: the bearer is started |
| Control | | Bits 0, 1 = 0b01: the bearer is stopped |
| | | Bits 0, 1 = 0b10: the bearer is resumed |
| | | Bit 2 = 0b0: source endpoint is present |
| | | Bit 2 = 0b1: source endpoint is not present |
| | | Bit 3 = 0b0: destination endpoint is present |
| | | Bit 3 = 0b1: destination endpoint is not present |
| | | Bit 4: 0b0: LL SDU Concatenation is enabled |
| | | Bit 4: 0b1: LL SDU Concatenation is not enabled |
| | | Bit 5: 0b0: LL SDU Segmentation is enabled |
| | | Bit 5: 0b1: LL SDU Segmentation is not enabled |
| QCI | 8 | QoS Class Indicator |
| Source | 0/8 | Logical endpoint of the source of the data bearer |
| Device | | 0x1: Host connected to FiRa Device |
| Endpoint | | 0x2: Secure Element connected to FiRa Device |
| | | 0x3~0xF: Reserved for other endpoints |
| Destination | 0/8 | Logical endpoint of the source of the data bearer |
| Device | | 0x1: Host connected to FiRa Device |
| Endpoint | | 0x2: Secure Component connected to FiRa Device |
| | | 0x3~0xF: Reserved for other endpoints |
| Source | 16/64 | Logical source address of the data bearer |
| Logical | | |
| Address | | |
| Destination | 16/64 | Logical destination address of the data bearer |
| Logical | | |
| Address | | |
| Guaranteed | 16 | This field only applies if QCI = 20(Guaranteed bitrate |
| Bitrate | | bearer). Unit is kbps. |
| Tx_Window | 8 | Tx window in unit of LL SDUs; it shall be less than 16 |
| Max_ReTx | 8 | Max retry count; it shall be less than 8 |
| Count | | |
| Rx_TimeOut | 8 | Rx TimeOut in slot unit |

ID field is the data bearer ID.

Status & Control indicates whether the data bearer is created, resumed or deleted; it also indicates whether SDU concatenation or segmentation is allowed for this data bearer.

QCI indicates the QoS Class Indicator of the created data bearer.

Source Device Endpoint and Destination Device Endpoint fields are the source and destination endpoints of the data bearer if they are present.

Source Address and Destination Address fields are the logical source and destination addresses of the data bearer.

Tx_Window is the window which the LLCU of the Controller assigns to the data bearer.

Max_Retry_Count is the max number of retransmissions of a LL SDU.

Rx_TimeOut indicates the time-out when the LL receiver may consider that the partially received SDUs are obsolete and may be flushed or that the peer device does not have any more data.

### QoS Definition and Management

The following classes of QoS are proposed in Table 9.

TABLE 9
QCI Classes

| | | Guaranteed | Guaranteed | Max Burst |
|---|---|---|---|---|
| Qos class | QCI | Latency | Bitrate | Size |
| Best Effort | 0 | NA | NA | NA |
| QoS Guaranteed with | 10 | 20 ms | NA | X |
| Guaranteed latency | | | | |
| QoS Guaranteed with | 11 | 50 ms | NA | X |
| Guaranteed latency | | | | |
| QoS Guaranteed with | 20 | NA | X | NA |
| Guaranteed bitrate | | | | |

This table of QoS classes can be extended in future releases.

QCI=10 or 11 is targeting short and bursted connections, like Requests/Responses with short latency.

QCI=20 is targeting connections for streaming applications.

The Controller LLCU shall not create more than one transmit QoS-guaranteed data bearer and one QoS-guaranteed receive data bearer per Controllee.

### Slot Allocation

At the beginning of the in-band data phase, the Controller LLCU shall allocate the slots of the in-band data phase in such a way that the QoS demands of the active data bearers (started or resumed) are satisfied as much as possible. Its slot allocation algorithm shall give the highest priority to the QoS-guaranteed data bearers with guaranteed latency, then to the QoS-guaranteed data bearers with guaranteed bitrate and eventually to the Best-effort data bearers. If the Controller LLCU can't allocate the UWB resources such that the QoS demand of a QoS-guaranteed data bearer is guaranteed, it shall send a status to the Upper Layer across the UCI, with the Connection whose QoS requirements can't be guaranteed.

It shall then deliver the slot allocation to MAC so that MAC builds the DPTCM.

The Controller LLCU shall also configure each data bearer: it shall set the values of Tx_Window, Max_ReTx_Count and Rx_TimeOut. It shall then deliver the Control SDU to MAC so that it is sent in slot 0 of the in-band data phase.

Typical values may be:

TABLE 10
Typical Values

| QCI | Tx_Window | Max_ReTx_Count | Rx_TimeOut |
|---|---|---|---|
| 0 | Max, i.e 16 (1) | Max, i.e 4 | Set by the Upper |
| | | | Layer |
| 10 or 11 | Max number of | 1 | Set by the Upper |
| | Application Data | | Layer |
| | per burst | | |
| 20 | Application Data | 2 | Set by the Upper |
| | Disorder Metric | | Layer |

Note
1: a Best Effort bearer typically intends to be reliable and to provide the highest throughput possible (therefore the Tx Window should be as large as possible).

A FiRa device may ignore the Tx_Window and Max_ReTx_Count for a receive data bearer or if the data bearer is not mapped to a connection (i.e is only created to convey ACK status). It may ignore Rx_TimeOut for a transmit data bearer.

### UCI Connection Control Messages

The Controller Host uses CONNECTION_CONTROL_SND UCI messages to start, stop or resume an Upper Layer connection between a Controller and a Controllee. The Controllee Host receives a CONNECTION_CONTROL_RCV UCI message to open, close or resume an Upper Layer connection according to the Controller request. There is one CONNECTION_CONTROL_MESSAGE per connection. See FIG. 4.

The Controller Host receives a CONNECTION_CONTROL_STATUS status from the UWBS to indicate the status of the request, i.e whether the Controller UWBS can successfully create, resume or stop the connection.

The Controller Host may also receive a CONNECTION_CONTROL_NTF notification if the Controller UWBS detects a failure or an abnormal behavior of a particular connection.

TABLE 11
MT Values

| MT | Description |
|---|---|
| 0b000 | Data Packet |
| 0b001 | Control Packet - Command message as Information |
| 0b010 | Control Packet - Response message as Information |
| 0b011 | Control Packet - Notification message as Information |
| 0b100 | Connection Control packet |
| 0b101- | RFU |
| 0b111 | |

### Packet Boundary Flag (PBF)

### UWB Session Management

### Connection Control Messages

Control Connection Snd or Rcv

TABLE 12
Connection_Control_Snd/Rcv
CONNECTION_CONTROL_SND

| Payload Field(s) | Length | Value/Description |
|---|---|---|
| ID | 8 | Connection ID |
| Command & Control | 8 | Bits 0, 1 = 0b00: Start the connection |
| | | Bits 0, 1 = 0b01: Stop the connection |
| | | Bits 0, 1 = 0b10: Resume the connection |
| | | Bit 2 = 0b0: source endpoint is present |
| | | Bit 2 = 0b1: source endpoint is not present |
| | | Bit 3 = 0b0: destination endpoint is present |
| | | Bit 3 = 0b1: destination endpoint is not present |
| | | Bit 4: 0b0: LL SDU Concatenation is allowed |
| | | Bit 4: 0b1: LL SDU Concatenation is not |
| | | enabled |
| | | Bit 5: 0b0: LL SDU Segmentation is allowed |
| | | Bit 5: 0b1: LL SDU Segmentation is not |
| | | allowed |
| QCI | 8 | QoS Class Indicator |
| Source Endpoint | 0/8 | Logical endpoint of the source of the |
| | | connection |
| | | 0x1: Host connected to FiRa Device |
| | | 0x2: Secure Element connected to FiRa Device |
| | | 0x3~0xF: Reserved for other endpoints |
| Destination Endpoint | 0/8 | Logical endpoint of the source of the |
| | | connection |
| | | 0x1: Host connected to FiRa Device |
| | | 0x2: Secure Element connected to FiRa Device |
| | | 0x3~0xF: Reserved for other endpoints |
| Source Address | 16/64 | Logical source address of the connection |
| Destination Address | 16/64 | Logical destination address of the destination |
| Guaranteed Bitrate | 16 | This field only applies if QCI = 20(Guaranteed |
| | | bitrate bearer). Unit is kbps. |
| Application Data Disorder | 8 | This field only applies if QCI = 20(Guaranteed |
| Metric | | bitrate bearer). |
| | | It is the number of Application Data which the |
| | | receiving device can be receive out-of-order |
| | | and reorder so that it is not perceived by the |
| | | client. It is typically the depth of the codec |
| | | Jitter Buffer. |
| Max_Burst_Size | 16 | This field only applies if QCI = 10 or 11 |
| | | (Guaranteed latency bearer). It is the cumulated |
| | | size of Application Data/burst |
| Max number of Application | 8 | This field only applies if QCI = 10 or 11 |
| Data per burst | | (Guaranteed latency bearer). |
| Receive_Inactivity_Timeout | 16 | Unit is in ms. If the Upper Layer does not |
| | | receive any Application Data during |
| | | Receive_Inactivity_Timeout, it may consider |
| | | that the peer does not have any Application |
| | | Data to transmit or that the radio channel has a |
| | | failure |

### Control Connection Status and Notification

TABLE 13
Connection_Control_Status
CONNECTION_CONTROL_STATUS

| Payload Field(s) | Length | Value/Description |
|---|---|---|
| Connection ID | 1 Octet | Connection ID for which this Status applies |
| Status Code | 1 Octet | Refer to Error! Reference source not found. for status c |
| | | odes |

TABLE 14
Status Code in Connection_Control_Status
Status Code values in the CONNECTION_CONTROL_STATUS

| Value | Description |
|---|---|
| 0x00 | STATUS_OK: the requested action has been successfully done by the UWBS |
| | controller |
| 0x01 | STATUS_ERROR: the requested action has failed |
| 0x02 | STATUS_PARTIAL_SUCCESS: this status code applies for Guaranteed |
| | QoS connections. The requested action has been successfully handled, but a |
| | Best-effort connection has been dropped |
| 0x04-0x1F | RFU |

TABLE 15
Connection_Control_NTF
CONNECTION_CONTROL_NTF

| Payload Field(s) | Length | Value/ Description |
|---|---|---|
| Connection ID | 1 Octet | Connection ID for which this Notification applies |
| Status Code | 1 Octet | Refer to Error! Reference source not found. for status c |
| | | odes |

TABLE 16
Status code of Connection_Control_NTF
Status Code values in the CONNECTION_CONTROL_NTF

| Value | Description |
|---|---|
| 0x00 | Connection Failure: the Controller can't successfully transmit Application |
| | Data to the Controllee |
| 0x01 | No More Data: the Controller does not receive any more data from the |
| | Controllee |
| 0x02 | The Connection has been dropped to release UWB resources for QoS |
| | Guaranteed Connections |
| | (this Error Code is only valid if the connection is a Best Effort connection) |
| 0x04-0x1F | RFU |

TABLE 17
Device Capability Parameters

| | Length | Tag | |
|---|---|---|---|
| Parameter Name | (Octets) | (IDs) | Description |
| CONCAT_SEG_SDU | 1 Octet | 0x00 | Bit 0: |
| | | | 0 - SDU fragmentation is not supported by the |
| | | | UWBS |
| | | | 1 - SDU fragmentation is supported by the UWBS |
| | | | Bit1: |
| | | | 0 - SDU concatenation is not supported by the |
| | | | UWBS |
| | | | 1 - SDU concatenation is supported by the UWBS |

What is claimed is:

1. An integrated circuit (IC) comprising:
an ultra-wideband (UWB) circuit comprising a control circuit configured to:
communicate with an application layer through a universal command and control interface (UCI) command; and
use link layer (LL) signals to communicate to a remote device.

2. The IC of claim 1, wherein at least one LL signal comprises a protocol data unit (PDU).

3. The IC of claim 2, wherein the PDU comprises a connection create command.

4. The IC of claim 2, wherein the PDU comprises a connection delete command.

5. The IC of claim 1, wherein the control circuit is configured to receive a quality of service (QOS) indication from the application layer.

6. The IC of claim 5, wherein the QoS indication comprises a guaranteed latency requirement.

7. The IC of claim 5, wherein the QoS indication comprises a guaranteed bitrate requirement.

8. The IC of claim 5, wherein the QoS indication comprises a best effort requirement.

9. The IC of claim 5, wherein the QoS indication is a per connection indication.

10. The IC of claim 5, wherein the QoS indication comprises a target delay between a request and a response.

11. The IC of claim 5, wherein the QoS indication comprises auxiliary information.

12. The IC of claim 11, wherein the control circuit is configured to use the auxiliary information to derive a maximum retransmission.

13. The IC of claim 11, wherein the control circuit is configured to use the auxiliary information to derive a transmission window.

14. The IC of claim 1, wherein the control circuit is configured to receive a signal over a signal bearer indicating that a connection is created.

15. The IC of claim 14, wherein the control circuit is further configured to notify an upper layer that a UWB logical connection is established.

16. The IC of claim 15, wherein the control circuit is further configured to begin application data transfer after notification of the establishment of the UWB logical connection.

17. The IC of claim 5, wherein the control circuit is configured to use multiple QoS indications across multiple connections, wherein each of the multiple QoS indications is received from the application layer.

18. The IC of claim 17, wherein the control circuit is further configured to allocate UWB slots based on QoS requirements.

19. The IC of claim 18, wherein UWB slot allocation is based on at least a maximum number of LL data retransmissions of the multiple connections.

20. The IC of claim 2, wherein the at least one LL signal is configured to use a signaling bearer with a predetermined identifier to convey control information of a logical connection to the remote device

21. The IC of claim 5, wherein the control circuit is configured to:
determine a maximum number of LL data retransmissions from the QoS indication; and
transmit the maximum number to a remote device in a control protocol data unit (PDU).

22. The IC of claim 5, wherein the control circuit is configured to:
determine a transmission window of LL data from the QoS indication; and
transmit a size of the transmission window to a remote device in a control protocol data unit (PDU).

23. The IC of claim 5, wherein the control circuit is further configured to:
determine a maximum lifetime of LL data from the QoS indication; and
transmit the maximum lifetime of the LL data to a remote device in a control protocol data unit (PDU).

24. The IC of claim 9, wherein the control circuit comprises a LL configured to translate the QoS indication and the auxiliary information into LL configuration parameters.

25. The IC of claim 24, wherein the LL configuration parameters comprise a maximum number of retransmissions of LL protocol data units (PDUs).

26. The IC of claim 24, wherein the LL configuration parameters comprise a maximum lifetime of upper layer data.

27. The IC of claim 24, wherein the control circuit is further configured to allocate UWB slots based on QoS requirements jointly with the LL configuration parameters.

28. The IC of claim 24, wherein the LL configuration parameters comprise an LL transmission window.
